(19) United States
(12) Patent Application Publication
(10) Pub. No.: US 2025/0369757 A1
(43) Pub. Date: Dec. 4, 2025

(54) PIPE ALIGNMENT KIT

(71) Applicant: Michael Piccinni, Fonthill (CA)

(72) Inventor: Michael Piccinni, Fonthill (CA)

(21) Appl. No.: 18/733,156

(22) Filed: Jun. 4, 2024

(51) Int. Cl. G01C 15/00; F16L 1/10

(52) U.S. Cl. CPC G01C 15/004; F16L 1/10

(57) ABSTRACT

A pipe alignment tool for determining a path of additional piping to be added onto an initial pipe includes a housing that contains a laser emitter. The housing has a front side, a back side, and a perimeter. The laser emitter is oriented to emit a laser forwardly with respect to the housing along an emission plane which extends through the front side and the back side of the housing. The laser emitter is pivotable with respect to the housing to select an orientation of the laser emitted by the laser emitter within a range of angles along the emission plane. An adapter bushing is removably couplable to the housing and has an outer surface sized and configured to fit in a pipe. The adapter is configured to align a central axis of the housing with a center axis of the pipe.

### (1) FIELD OF THE INVENTION

The disclosure relates to pipe alignment tools and more particularly pertains to a new pipe alignment tool for determining a path of additional piping to be added onto an initial pipe.

### (2) DESCRIPTION OF RELATED ART INCLUDING INFORMATION DISCLOSED UNDER 37 CFR 1.97 AND 1.98

The prior art relates to pipe alignment tools which use a laser emitter positioned in an open end of an initial pipe to emit a laser along a centerline of planned additional piping. Such tools may be used to determine obstructions which must be removed or bored through to make way for the additional piping and to plan for other tasks such as adding supports for the additional piping. Some such pipe alignment tools include calibration means for aligning a laser emitted by a laser emitter to a central axis of the initial pipe. However, the prior art fails to disclose such a tool which would accept inputs to change the angle of the emitted laser. The prior art also fails to disclose such a tool which uses one or more reflector apparatuses to plan for the additional piping to make one or more abrupt changes in direction along its path.

### BRIEF SUMMARY OF THE INVENTION

An embodiment of the disclosure meets the needs presented above by generally comprising a housing that contains a laser emitter. The housing has a front side, a back side, and a perimeter. The perimeter extends between the front side and the back side. The laser emitter is oriented to emit a laser forwardly with respect to the housing along an emission plane which extends through the front side and the back side of the housing. The laser emitter is pivotable with respect to the housing to select an orientation of the laser emitted by the laser emitter within a range of angles along the emission plane. An adapter bushing is removably couplable to the housing and has an outer surface sized and configured to fit in a pipe. The adapter is configured to align a central axis of the housing with a center axis of the pipe.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a perspective view according to an embodiment of the disclosure.

FIG. 2 is a top exploded view of an embodiment of the disclosure.

FIG. 3 is a first side view of an embodiment of the disclosure.

FIG. 4 is a front view of an embodiment of the disclosure.

FIG. 5 is a second side view of an embodiment of the disclosure.

FIG. 6 is an in-use view of an embodiment of the disclosure.

FIG. 7 is an in-use view of an embodiment of the disclosure.

FIG. 8 is a block diagram of an embodiment of the disclosure.

### DETAILED DESCRIPTION OF THE INVENTION

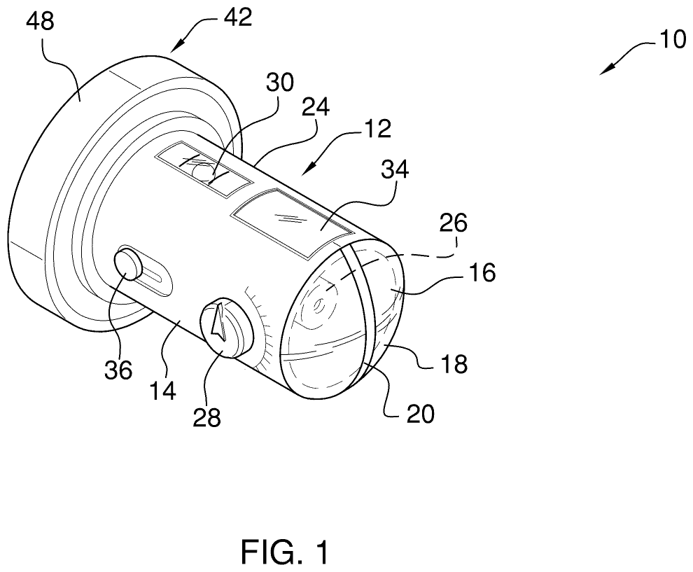

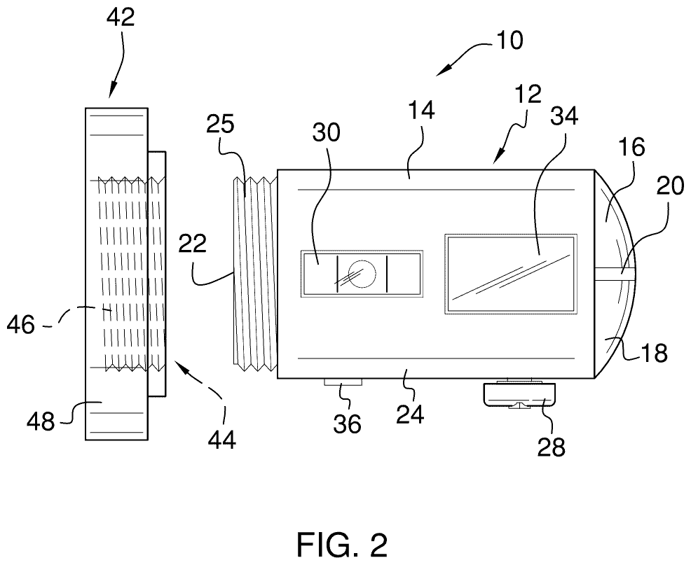

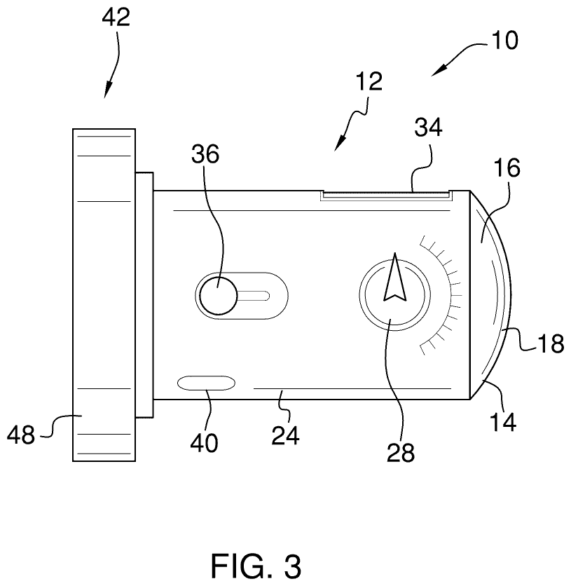

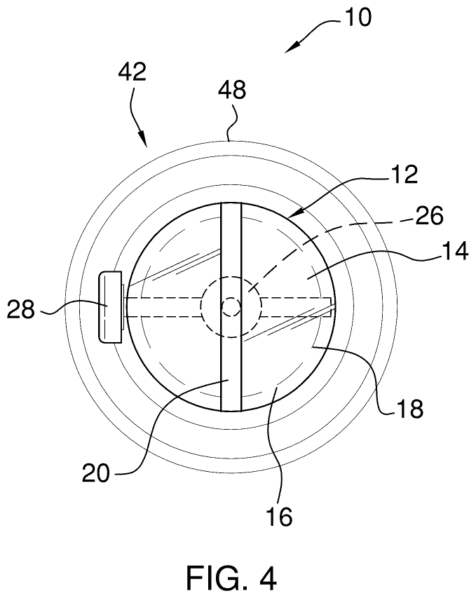

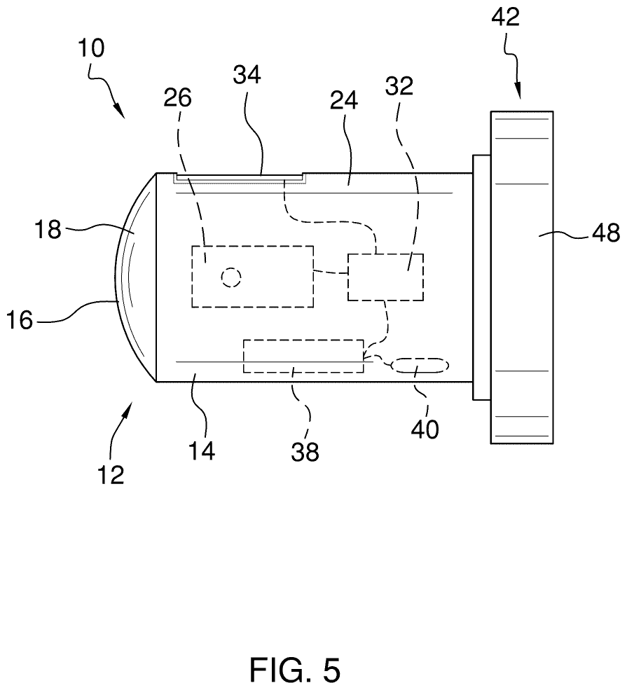

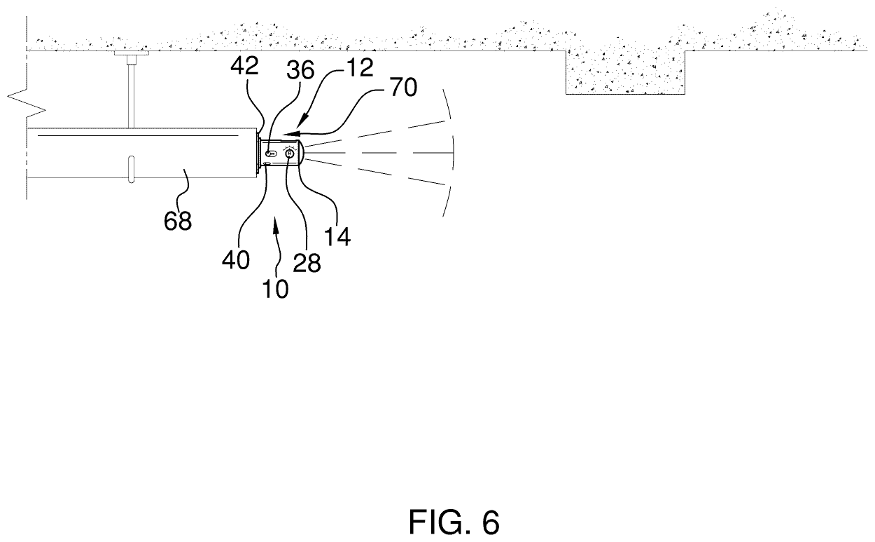

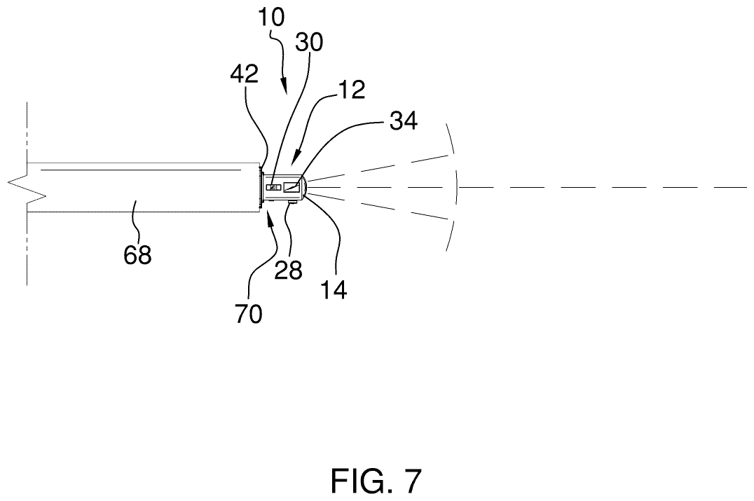

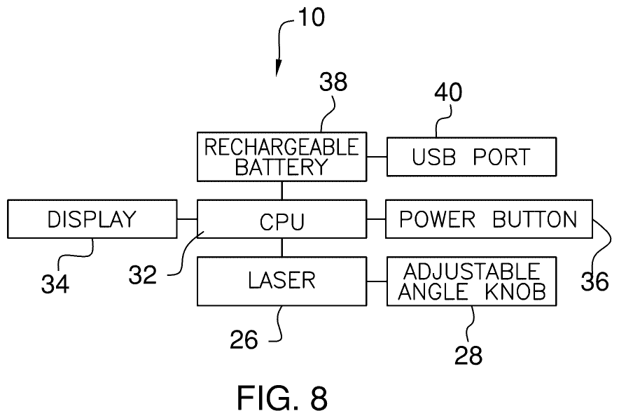

With reference now to the drawings, and in particular to FIGS. 1 through 8 thereof, a new pipe alignment tool embodying the principles and concepts of an embodiment of the disclosure and generally designated by the reference numeral 10 will be described.

As best illustrated in FIGS. 1 through 8, the pipe alignment tool 10 generally comprises a housing 14 and a laser emitter 26 contained in the housing 14. The housing 14 has a front side 16, a back side 22, and a perimeter 24. The perimeter 24 extends between the front side 16 and the back side 22. The laser emitter 26 is oriented to emit a laser forwardly with respect to the housing 14 along an emission plane which extends through the front side 16 and the back side 22 of the housing 14. The laser emitter 26 is pivotable with respect to the housing 14 to select an orientation of the laser emitted by the laser emitter 26 within a range of angles along the emission plane. The laser emitter 26 is orientable to align the emitted laser with a central axis of the housing 14.

The front side 16 of the housing 14 comprises a shielding portion 18 and a gateway portion 20. The gateway portion 20 is elongated and extends along the emission plane, bisecting the shielding portion 18. The shielding portion 18 is opaque to block the laser emitted by the laser emitter 26, and the gateway portion 20 is transparent to facilitate the laser emitted by the laser emitter 26 to pass through the gateway portion 20. The gateway portion 20 may comprise glass, a clear plastic, or the like. In some embodiments, the gateway portion 20 may be an aperture defined by the shielding portion 18.

A grade selector input 28 is operatively coupled to the laser emitter 26. The grade selector input 28 comprises a knob mounted on the housing 14. By turning the knob, an orientation of the laser emitter 26 with respect to the housing 14 may be selected. An emitter level 30 is mounted to the housing 14 and is configured to indicate a levelness of the central axis of the housing 14. The emitter level 30 comprises a bubble level but may comprise any suitable type of level, including electronic types using inclinometers, accelerometers, or the like.

A processor 32 is operatively coupled to the laser emitter 26. A display 34 is mounted on the housing 14 and is operatively coupled to the processor 32. The processor 32 causes the display 34 to present grade data indicating the grade of the emitted laser, which the processor 32 may obtain from the grade selector input 28 or by sensing an actual orientation of the laser emitter 26 via an inclinometer or like sensing device. An activation switch 36 is in operative communication with the processor 32, and the processor 32 is programmed to activate the laser emitter 26 upon actuation of the activation switch 36. A battery 38 is electrically coupled to the processor 32, and a charging port 40 is electrically coupled to the battery 38. In some embodiments, the processor 32 may be powered by an external power source. In some embodiments, the battery 38 may be accessible via an access door or the like for maintenance or replacement.

An adapter bushing 42 is provided to removably couple to the housing 14 and position the housing 14 in an open end of a pipe. In some embodiments, several adapter bushings 42 configured for pipes of different bore sizes may be provided and interchangeably mountable to the housing 14. The adapter bushing 42 couples to the housing 14 at its back side 22 via a threaded coupling. The adapter bushing 42 defines a cavity 44 with internal threads 46 that mesh with external threads 25 of the housing 14. The external threads 25 of the housing 14 are positioned on the perimeter 24 adjacent to the back side 22 of the housing 14. The adapter bushing 42 may couple to the housing 14 via any suitable means, such as a latch, a magnet, a snap connection, or the like. The adapter bushing 42 has an outer surface 48 which is cylindrical in shape and which is sized to fit snugly in the pipe. Diameters of adapter bushings 42 corresponding to standard pipe bore sizes may be used. When the laser emitter 26 is oriented to emit a laser in alignment with the central axis of the housing 14 and the housing 14 is mounted to the pipe via the adapter bushing 42, the laser aligns with a center axis of the pipe.

In use, the adapter bushing 42 is attached to the housing 14. In embodiments with several adapter bushings 42, one of the adapter bushings 42 is selected to fit in an initial pipe 68 intended to be used to determine the alignment of additional pipe. The housing 14 is then mounted in an open end 70 of the initial pipe 68 via the adapter bushing 42, which has a close fit with an interior surface of the initial pipe 68. A grade is selected for the laser emitter 26 to emit a laser from the open end 70 of the initial pipe 68. The grade may be selected to conform to the grade of the initial pipe 68 or may deviate from the same. The activation switch 36 is actuated to cause the laser emitter 26 to emit the laser in the selected orientation.

The laser may be used to identify obstructions which need to be removed or bored through to install the additional pipe in the desired pathway and to determine locations and sizes of support means such as pipe hangers to mount the additional pipe to a structure. For the latter use, an obstruction such as a loose board may be placed in an approximate area where a support structure will couple to the additional pipe in the path of the laser. The laser illuminates a spot on the board which indicates the intended center of the additional pipe at that point in the desired pathway. Measurements may be made from that point to a nearby structure to determine types and sizes of support means to be used to support the additional pipe.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A pipe alignment tool comprising:
a housing having a front side, a back side, and a perimeter, the perimeter extending between the front side and the back side;
a laser emitter mounted in the housing, the laser emitter being oriented to emit a laser with respect to the housing along an emission plane which extends through the front side and the back side of the housing, the laser emitter being pivotable with respect to the housing to select an orientation of the laser emitted by the laser emitter within a range of angles along the emission plane; and
an adapter bushing removably couplable to the housing, the adapter bushing having an outer surface sized and configured to fit in a pipe, the adapter being configured to align a central axis of the housing with a center axis of the pipe.

2. The kit of claim 1, wherein the laser emitter is orientable to align the emitted laser with a central axis of the housing.

3. The kit of claim 1, wherein the front side of the housing comprises a shielding portion and a gateway portion, the gateway portion bisecting the shielding portion, the gateway portion being elongated and extending along the emission plane, the shielding portion being opaque to block the laser emitted by the laser emitter, the gateway portion being configured to facilitate the laser emitted by the laser emitter to pass through the gateway portion.

4. The kit of claim 3, wherein the gateway portion is transparent to facilitate the laser emitted by the laser emitter to pass through the gateway portion.

5. The kit of claim 1, further comprising a grade selector input operatively coupled to the laser emitter.

6. The kit of claim 5, wherein the grade selector input comprises a knob to select an orientation of the laser emitter with respect to the housing.

7. The kit of claim 1, further comprising an emitter level mounted to the housing, the emitter level being configured to indicate a levelness of the central axis of the housing.

8. The kit of claim 1, further comprising a display mounted to the housing, the display being configured to present grade data indicating the grade of the emitted laser.

9. The kit of claim 1, wherein the outer surface of the adapter bushing comprises a cylindrical shape.

10. The kit of claim 1, wherein the adapter bushing defines a cavity for receiving the housing.

11. The kit of claim 10, wherein the adapter has internal threads which mesh with external threads of the housing, the external threads of the housing being positioned on the perimeter adjacent to the back side of the housing.

12. A pipe alignment tool comprising:
a housing having a front side, a back side, and a perimeter, the perimeter extending between the front side and the back side;
a laser emitter mounted in the housing, the laser emitter being oriented to emit a laser along an emission plane which extends through the front side and the back side of the housing, the laser emitter being pivotable with respect to the housing to select an orientation of the laser emitted by the laser emitter within a range of angles along the emission plane, the laser emitter being orientable to align the emitted laser with a central axis of the housing;
wherein the front side of the housing comprises a shielding portion and a gateway portion, the gateway portion bisecting the shielding portion, the gateway portion being elongated and extending along the emission plane, the shielding portion being opaque to block the laser emitted by the laser emitter, the gateway portion being transparent to facilitate the laser emitted by the laser emitter to pass through the gateway portion;
a grade selector input operatively coupled to the laser emitter, the grade selector input comprising a knob to select an orientation of the laser emitter with respect to the housing;
an emitter level mounted to the housing, the emitter level being configured to indicate a levelness of the central axis of the housing;
a display mounted to the housing, the display being configured to present grade data indicating the grade of the emitted laser; and
an adapter bushing removably couplable to the housing, the adapter bushing having an outer surface sized and configured to fit in a pipe, the adapter being configured to align the central axis of the housing with a center axis of the pipe, the outer surface having a cylindrical shape, the adapter bushing defining a cavity for receiving the housing, the adapter having internal threads which mesh with external threads of the housing, the external threads of the housing being positioned on the perimeter adjacent to the back side of the housing.
